(19) United States
(12) Patent Application Publication
(10) Pub. No.: US 2014/0278870 A1
(43) Pub. Date: Sep. 18, 2014

(54) Method and Apparatus for Encouraging Vehicle Infotainment System Usage

(71) Applicant: FORD GLOBAL TECHNOLOGIES, LLC, Dearborn, MI (US)

(72) Inventor: James Dragescu, San Diego, CA (US)

(73) Assignee: FORD GLOBAL TECHNOLOGIES, LLC, Dearborn, MI (US)

(21) Appl. No.: 13/826,624

(22) Filed: Mar. 14, 2013

(51) Int. Cl. G06Q 30/02

(52) U.S. Cl. CPC G06Q 30/0226
USPC 705/14.19; 705/14.27

(57) ABSTRACT

A system includes a processor configured to provide a first structured incentive responsive to the use of a first vehicle feature. The processor is further configured to store aggregated structured incentives. The processor is also configured to determine a second vehicle feature to be used, which will result in provision of a second structured incentive. Finally, the processor is configured to recommend usage of the second vehicle feature

### TECHNICAL FIELD

The illustrative embodiments generally relate to a method and apparatus for encouraging vehicle infotainment system usage.

### BACKGROUND

Millions of vehicles now on the road include vehicular infotainment systems. These systems allow users to connect smart phones, access music and application, provide multimedia in a vehicle, provide navigation to a vehicle, and perform numerous other functions.

As with many vehicle features, numerous options and usage scenarios are not always apparent to users. Users often develop a comfort zone with commonly used features and ignore countless others. Once a user has “settled in” with a comfortable set of features, the chances of the user taking advantage of remaining features is very low. Unfortunately, this often deprives a user of an advanced vehicle experience that the user doesn't even know exists.

### SUMMARY

In a first illustrative embodiment, a system includes a processor configured to provide a first structured incentive responsive to the use of a first vehicle feature. The processor is further configured to store aggregated structured incentives. The processor is also configured to determine a second vehicle feature to be used, which will result in provision of a second structured incentive. Finally, the processor is configured to recommend usage of the second vehicle feature.

In a second illustrative embodiment, a computer-implemented method includes providing a first structured incentive responsive to the use of a first vehicle feature. The method also includes storing aggregated structured incentives. The method further includes determining a second vehicle feature to be used, which will result in provision of a second structured incentive. Further, the method includes recommending usage of the second vehicle feature.

In a third illustrative embodiment, a non-transitory computer-readable storage medium stores instructions that, when executed by a processor, cause the processor to perform the method including providing a first structured incentive responsive to the use of a first vehicle feature. The exemplary method also includes storing aggregated structured incentives. The method further includes determining a second vehicle feature to be used, which will result in provision of a second structured incentive. Further, the method includes recommending usage of the second vehicle feature.

### BRIEF DESCRIPTION OF THE DRAWINGS

FIG. 1 shows an illustrative vehicle computing system;

FIG. 2 shows an illustrative example of a user interaction analysis process;

FIG. 3 shows an illustrative example of a feature tracking update process;

FIG. 4 shows an illustrative example of a usage reporting screen;

FIG. 5 shows an illustrative example of an incentive presentation process; and

FIG. 6 shows an illustrative example of an opportunity presentation process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Although common owners only use a fraction of the capabilities that are available to them on a vehicle infotainment system, there are proposed, herein, a number of exemplary embodiments of methods and systems to encourage system usage. This helps enhance the customer experience, build owner loyalty, and to allow occupants to enjoy full usage of vehicular capabilities.

By rewarding occupants for commonly using popular features and/or for using new or previously un-used features, OEMs can provide greater penetration into the user experience. This can also help OEMs deliver information about newly added features for updated infotainment system. That is, instead of simply telling a user about a new feature, incentive based participation programs can notify the user and encourage usage of the feature. In this manner, the feature is used, feedback for improvement can be obtained, and the user experience is enhanced.

FIG. 2 shows an illustrative example of a user interaction analysis process. In this illustrative example, the process detects when a tracked feature is being used 201. Tracked features can include, but are not limited to, phone, navigation, media, climate control and other infotainment and vehicle-related features. In this illustrative example, points are provided for usage of a feature. These can be one-time points, points for a certain amount of usages per month, or distributed in any other appropriate manner.

In this illustrative embodiment, the tracked features have at least some measure of points associated therewith. The process next accesses a points database 203 to determine if there are any points available for the usage of the feature 205. In this case, there may not be points available because a user has obtained all of the available points for usage of a particular feature (either overall or for a certain time period). Even if there are not points available, there may be points for the user to take an additional step related to the accessed feature. For example, if the user turns on the heat or air, and has obtained all the points for HVAC usage, there may still be options for points. If the vehicle is outfitted with heated/cooled seats, the system may encourage the user to actuate one of those features if doing so will result in points. This then provides the user with additional points, while also making the user aware of the feature which may not have otherwise been used.

In this process, the system checks to see if there are any additional points available with “next-steps” 217, which are, essentially, follow on steps to the detected action. In other examples, the additional points could be associated with unrelated features, for example, features that a manufacturer wishes to promote, or other features that may be relevant for some OEM determined reason. If there are additional points that fit a delivery criteria, the process recommends next steps to be taken 219 to obtain the points. If the user follows through with the steps 221, the process then proceeds back to the points database for scoring the steps.

If there are points available with a feature usage, the process may notify the user that points have been awarded 207, and provide the points to the user 209. These can be stored on a local system, on a remote system or some combination of both. Points can also be uploaded to a cell phone or provided to another medium for transport and/or comparison.

Also, the user may wish to provide feedback for additional points 211. In this case, the feedback can be as simple as answering a single question or as complex as filling out an entire survey. Feedback can be tailored as a manufacturer sees fit, in order to gather information in a manner that the OEM deems appropriate (minimize user interaction to encourage participation, fully engaged surveys for more points and higher-quality feedback, etc.). Then, when the feedback is completed, or not chosen, the process can check for possible next-steps.

FIG. 3 shows an illustrative example of a feature tracking update process. In this illustrative example, the process is periodically or continually in communication with a points server to update a store of points on a local system (or retrieve points for a drive experience, for example).

In this example, a local vehicle process (or a process running on a remote server), accesses a remote database containing the current point options 301. These relate to, for example, points that are available for all vehicles of all makes and models, or for certain lines, builds, etc. New options may be flagged as such and dated, and a last-update date can be compared. In other instances, new points may be determined by comparison to previously available stored options, or in any other suitable manner. If new point options are available 303, one or more of the new options will be selected. In a database where a number of vehicle options are stored at once, the points may correspond to one or more specific vehicles 305 (or builds, option packages, etc.). If the points are not specific to any one model or build, the process may retrieve the option 307 and notify the user of the new options 313. Notification may wait until all new point options are retrieved, if the points are not all retrieved at once, for example.

If the point options are vehicle specific, the process may then compare the model/build requirements to a given point option 309 to determine if the points are relevant for a given vehicle. If the vehicle is “eligible” (i.e., if it has the requisite feature or function), then the process will retrieve the point option for presentation and/or storage. This retrieval of point options can be done all at once, or, as in this example, can continue until all appropriate options have been retrieved.

FIG. 4 shows an illustrative example of a usage reporting screen 401. This is an example of an in-vehicle or online report (or, for example, an app screen) that shows a user's current and overall point accumulation. Point redemption options, if available can also be provided or linked. Other suitable options may also be provided. In this illustrative example, user personal information is shown 403. This represents the account that is currently obtaining the points. In case a wrong user is identified, the driver or other user could re-login. Personal information could also be updated by this screen.

Also, a vehicle identification number can be provided 405 in conjunction with vehicle make and model identifying information (not shown). A software version of the current VCS software may be shown as well.

Additionally, if desired, phone information 407 may be shown, corresponding to a user's phone. This can include, but is not limited to, a manufacturer, a carrier, software on the phone, whether a phone is currently supported, etc. All of this information can be updated by a user if desired or appropriate.

Finally, in this example, a media storage capability 409 can be shown. This represents, for example, a device previously used to update a system or to previously connect to a vehicle computing system storage. Support and specifications on the memory capability device may also be shown.

This screen further shows a user identification 411, and, in this example, provides a month-to-date 413 analysis of all points accumulated. In this example, these points correspond to points from various feature usage 415, as well as a ranking associated with a particular score. Year over year points, daily points and any other suitable point statistics can be provided. This page can also provide access to score leaders and other comparison features or point redemption features if appropriate.

FIG. 5 shows an illustrative example of an incentive presentation process. In this illustrative example, it is considered that an OEM or other party will provide incentives to drivers in exchange for points. The points could be turned in or incentives could be presented based on achieved point levels. Other suitable paradigms could also be used.

In this illustrative example, the process will present a user with one or more possible incentives 501. In this case, the process may present incentives that correspond not only to available incentives, but also incentives that could be available if certain point options were achieved. The user may select an incentive for purchase or information, and the process receives the selection 503.

If the user can afford the selected incentive, based on the program structure 505, the process may determine the cost for the incentive and charge the points 507 (or credit the user as having selected the given incentive, if points are not charged, etc.). The user can then be provided with the appropriate incentive (digital song, upgrade, new avatar for system, etc.). The incentive can be anything the manufacturer or provider deems appropriate.

If the user cannot afford the selected incentive, the process may determine a cost difference 511 or other level needed to achieve the incentive. Then, in this example, the process examines commonly used features 513. This is so that a presented strategy corresponds to features that are most likely to be used by a given user. For example, if a user commonly uses a radio and CD player, the process may recommend an MP3 player usage or other entertainment related system. In other examples, the process could additionally or alternatively provide manufacturer preferred incentives. Other suitable incentive strategies could also be used.

Once a reasonable strategy for obtaining the missing points or level has been determined, the process may recommend the strategy for user implementation 515. The user could then select or follow through with one or more of the recommended processes. Otherwise, if the processes are not all used, the process could store the recommendations for suggestion at a later date. The process could also display the incentive and show the user updated progress reports on achievement status as well.

FIG. 6 shows an illustrative example of an opportunity presentation process. In this illustrative example, the process examines a user's all time usage 601 (or monthly usage, or daily usage, etc.). Also included in this example are vehicle states (parked, driving, high-distraction, etc., as well as states such as environmental states, road-type, music playing, etc.) 603. Based on usage history, response to previous suggestions, etc, the system can identify possible opportunities of which a user is likely to take advantage 605.

If opportunities exist 607, the system can also determine (based on vehicle states, for example), whether or not it is safe for the user to be presented with the opportunities 609. For example, it is probably more reasonable to present user suggestions when a vehicle is in a parked state, or when a non-driver user is interacting with the system and can perform the suggested functions. Some function options, although, may be appropriate even in a moving state or stopped at a light (such as change a climate setting, input a radio preset, etc.). The system can appropriately determine which features are suitable when, and can provide the features accordingly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
provide a first structured incentive responsive to the use of a first vehicle feature;
store aggregated structured incentives;
determine a second vehicle feature to be used, which will result in provision of a second structured incentive; and
recommend usage of the second vehicle feature.

2. The system of claim 1, wherein the processor is configured to store aggregated structured incentives locally on a vehicle computer.

3. The system of claim 1, wherein the processor is configured to store aggregates structured incentives through reporting to a remote processor for storage.

4. The system of claim 1, wherein the processor is further configured to:
determine if the use of the first vehicle feature qualifies for the structured incentive; and
provide the structured incentive based on the determination that the use of the first vehicle feature qualifies for the structured incentive.

5. The system of claim 1, wherein the second vehicle feature is in a same category as the first vehicle feature, based on a predetermined list of categories.

6. The system of claim 1, wherein the processor is further configured to:
request feedback on the use of at least one vehicle feature;
gather feedback;
report feedback to a remote server; and
provide a third structured incentive upon completion of feedback.

7. The system of claim 1, wherein the first and second structured incentives comprise points.

8. A computer-implemented method comprising:
providing a first structured incentive responsive to the use of a first vehicle feature;
storing aggregated structured incentives;
determining a second vehicle feature to be used, which will result in provision of a second structured incentive; and
recommending usage of the second vehicle feature.

9. The method of claim 8, wherein storing aggregated structured incentives is done locally on a vehicle computer.

10. The method of claim 8, wherein storing aggregated structured incentives is done through reporting to a remote processor for storage.

11. The method of claim 8, further including:
determining if the use of the first vehicle feature qualifies for the structured incentive; and
wherein the providing the structured incentive is based on the determination that the use of the first vehicle feature qualifies for the structured incentive.

12. The method of claim 8, wherein the second vehicle feature is in a same category as the first vehicle feature, based on a predetermined list of categories.

13. The method of claim 8, further comprising:
requesting feedback on the use of at least one vehicle feature;
gathering feedback;
reporting feedback to a remote server; and
providing a third structured incentive upon completion of feedback.

14. The method of claim 8, wherein the first and second structured incentives comprise points.

15. A non-transitory computer-readable storage medium, storing instructions that, when executed by a processor, cause the processor to perform the method comprising:
providing a first structured incentive responsive to the use of a first vehicle feature;
storing aggregated structured incentives;
determining a second vehicle feature to be used, which will result in provision of a second structured incentive; and
recommending usage of the second vehicle feature.

16. The storage medium of claim 15, wherein storing aggregated structured incentives is done locally on a vehicle computer.

17. The storage medium of claim 15, wherein storing aggregated structured incentives is done through reporting to a remote processor for storage.

18. The storage medium of claim 15, wherein the method further includes:
determining if the use of the first vehicle feature qualifies for the structured incentive; and
wherein the providing the structured incentive is based on the determination that the use of the first vehicle feature qualifies for the structured incentive.

19. The storage medium of claim 15, wherein the second vehicle feature is in a same category as the first vehicle feature, based on a predetermined list of categories.

20. The storage medium of claim 15, wherein the method further includes:
requesting feedback on the use of at least one vehicle feature;
gathering feedback;
reporting feedback to a remote server; and
providing a third structured incentive upon completion of feedback.
